(19) United States
(12) Patent Application Publication
(10) Pub. No.: US 2024/0328543 A1
(43) Pub. Date: Oct. 3, 2024

(54) TYPE MODULE FOR THE CREATION OF DUCTS FOR THE CIRCULATION OF AIR AND DUCT OBTAINED WITH THIS MODULE

(71) Applicant: Sinteco Impianti S.r.l., Sesto San Giovanni (IT)

(72) Inventor: Diego COLOMBO, Sesto San Giovanni (IT)

(21) Appl. No.: 18/608,987

(22) Filed: Mar. 19, 2024

(30) Foreign Application Priority Data
Mar. 29, 2023 (IT) 102023000006018

(51) Int. Cl. F16L 9/00; F16L 59/14

(52) U.S. Cl. CPC F16L 9/003; F16L 59/143

(57) ABSTRACT

A module for air circulation ducts, of the type consisting of a quadrangular body formed by panels (6) mutually assembled at their longitudinal edges and provided with sections (4) for air transit between adjacent modules (5). According to the invention, said panels (6) have a sandwich-type monolithic structure, having a central body (7) of heat-insulating material, coated on the external surfaces with a layer (8) of protective stiffening material. In comparison with the known ducts, the duct according to the invention offers the advantage that the creation of pre-formed modules, i.e. provided with their own insulation and coating, made monolithically within the structure of the modules, allows the stable fitting of the insulation and coating on the module and therefore also on the final duct as a whole, even at the joints thereof.

### BACKGROUND OF THE INVENTION

The present invention concerns an improved type module for the creation of ducts for the circulation of air in civil and industrial environments. The invention also concerns the duct created with this module.

The field of the invention is that of ducts which are used to circulate air from an external environment to an internal environment and vice versa, such as for example the ducts used to distribute air in environments with a high level of hygiene and, vice versa, to send the air from such environments towards the outside.

In this field of application, it is known to use ducts, made up of sheet metal modules and the like, mutually assembled to construct the duct and subsequently insulated with a layer of heat-insulating material, the latter in turn coated with a layer of covering material.

The known ducts described above have the drawback that coating with insulating material, which is necessary to avoid condensation and thermal dispersion phenomena, must be carried out after the assembly of the modules that form the final duct. This does not allow the desired airtightness of the internal environment to the external environment to be achieved, particularly at the joints, because it is more difficult to obtain the desired air seal and thermal insulation at the joints.

Furthermore, precisely because of this sealing defect between the module joints, some particles or fragments of insulating material that have not completely or firmly stuck to the walls of the module may break loose and get inside the duct, then spreading throughout the environment in which the air is circulated.

In addition, the application of the insulation after assembly of the duct causes defects in the stability of the fitting of the insulation to the walls of the duct, with possible detachment phenomena.

### SUMMARY OF THE INVENTION

The main object of the present invention is to provide an improved type of duct which allows the aforementioned drawbacks of the prior art to be overcome.

This and other objects are achieved with the module and with the duct of claims 1 and 11, respectively. Preferred embodiments of the invention will be apparent from the remaining claims.

Compared to the known ducts, the duct according to the invention offers the advantage that the creation of pre-formed modules, i.e. provided with their own insulation and coating, made monolithically within the structure of the modules, allows a stable fitting of the insulation and coating on the module and therefore also on the final duct as a whole, even at the joints thereof.

This ensures the necessary air sealing conditions and therefore thermal insulation and airtightness between the external and internal environments, avoiding the risks of foreign materials infiltrating into the environments, especially in the food, pharmaceutical and similar sectors.

A further advantage of the invention is represented by the possibility of calibrating the thickness of the insulation according to specific needs, making it possible to select even high thicknesses without the risk of detachment of the insulation and the external coating during use.

Compared to the prior art, the duct of the invention also offers the advantage of greater lightness, thanks to the possibility of using lighter materials for the manufacture of the modules than those (such as metal and the like) which are necessary when creating the cover of the duct after its assembly.

A further advantage is represented by the fact that the modules of the duct of the invention are formed by assembling prefabricated panels of plastic material, preferably fiberglass, which incorporate the insulating material. In this way, compared to traditional modules made by bending and cutting sheet metal, which must then be insulated, coated and flanged, the modules forming the duct of the invention are lighter.

This in turn allows the creation of single sections of duct even more than ten meters long, which is not normally possible to achieve with traditional sheet metal modules.

For the same reason it is possible to create modules with sections of variable width depending on the transport capacity of the duct.

### BRIEF DESCRIPTION OF THE DRAWINGS

These and other objects, advantages and features result from the following description of some preferred embodiments of the duct of the invention illustrated, by way of non-limiting examples, in the Figures of the attached drawing sheets. In these:

FIG. 1 illustrates an example of an embodiment of the invention;

FIG. 1A illustrates a variant of the duct in FIG. 1;

FIG. 2 illustrates an example of a monolithic pre-assembled module of the duct in FIGS. 1 and 1A;

FIG. 2A shows an exploded view of the module in FIG. 2;

FIG. 2B shows an exploded view of the structure of a panel forming the module in FIG. 2;

FIG. 3 shows an exploded view of the external stiffening or reinforcement ring of the module in FIG. 2;

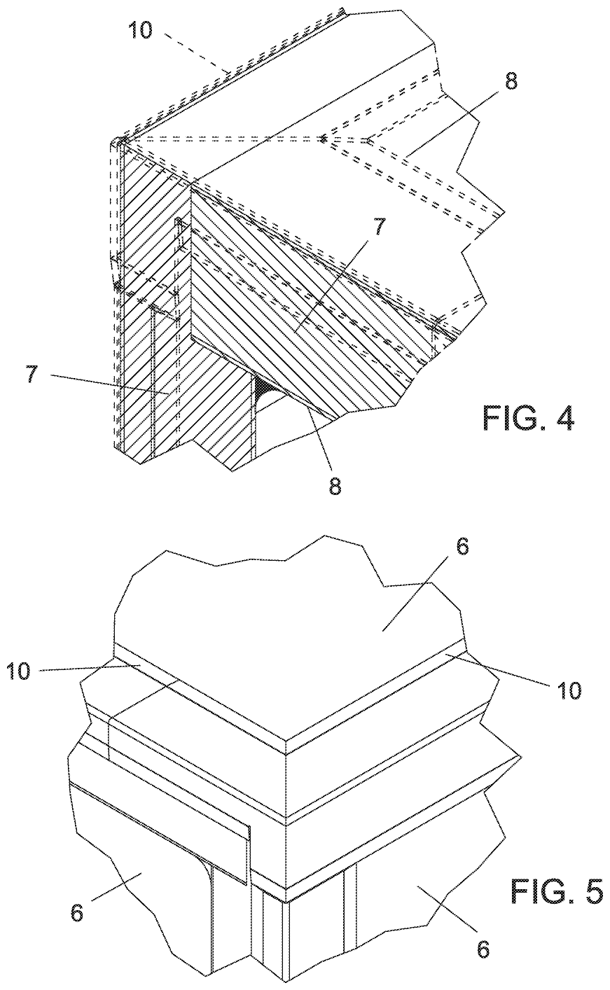

FIG. 4 illustrates the detail of the connection between the panels of the module in FIG. 2, before the application of the external reinforcement ring in FIG. 3;

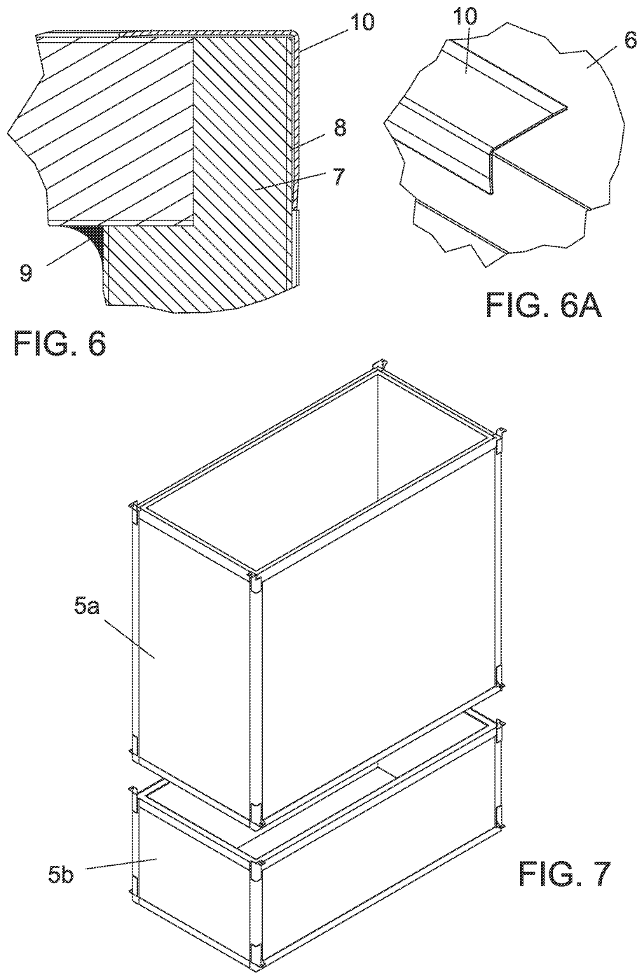

FIGS. 5, 6 and 6A are perspective and cross-section views of the detail of the connection between the panels of the module in FIG. 2, completed with the ring in FIG. 3;

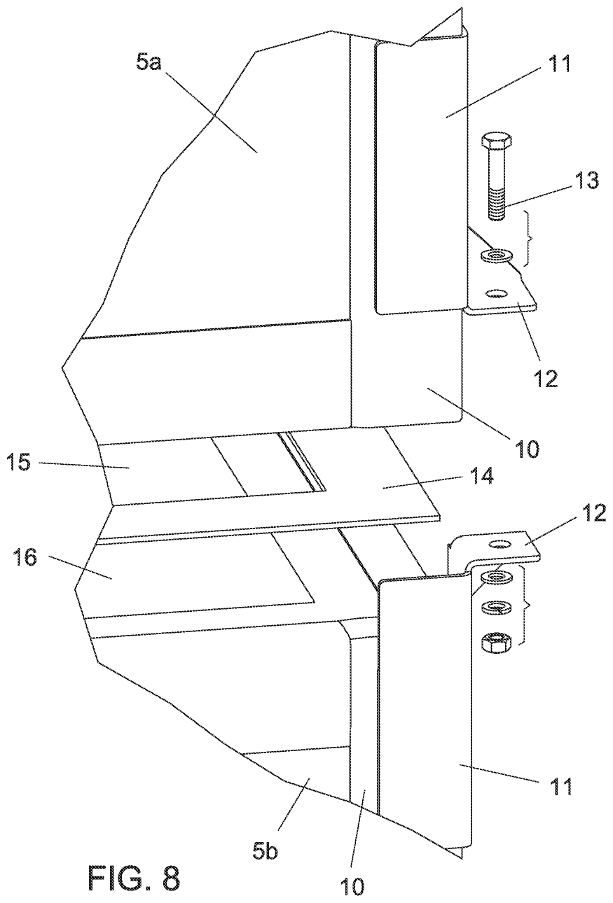

FIGS. 7 and 8 illustrate the coupling between two modules of equal dimensions;

FIGS. 9, 9A and 9B illustrate the solution for the coupling between modules of the invention of different dimensions;

FIGS. 10, 10A and 10B illustrate the coupling between the modules of FIG. 2, with the interposition of a joint for the dimensional compensation of the duct;

FIG. 11 illustrates a variant of the module of the invention with internal deflectors;

FIGS. 12 and 12A illustrate the module of the invention, with a view of the detail of the wash water drain;

FIG. 13 illustrates the module of the invention with a view of the air inlet/outlet section;

FIGS. 14 and 14A are perspective and cross-section views of the access door into the modules of the invention;

FIG. 15 illustrates a further variant of the module of the invention.

### DETAILED DESCRIPTION OF THE PREFERRED EMBODIMENTS

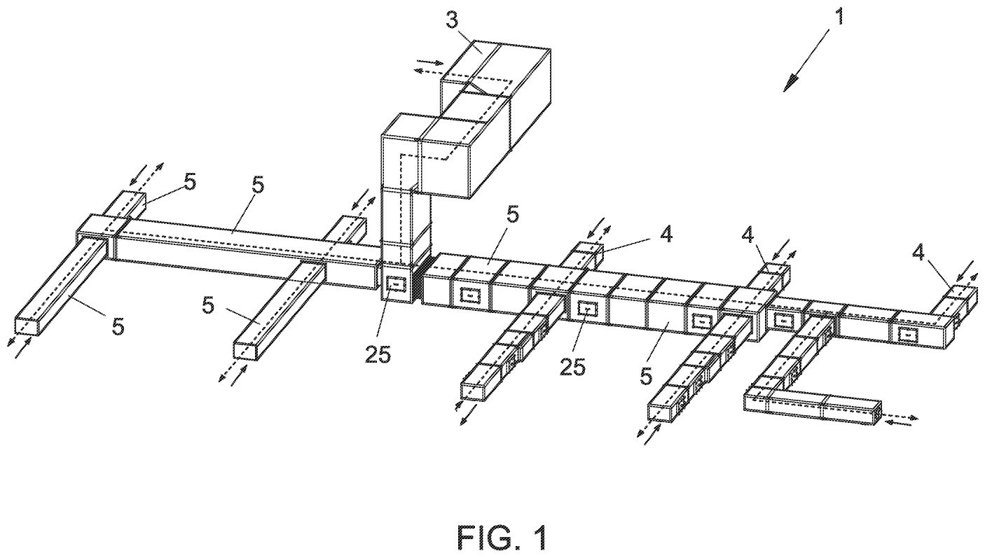

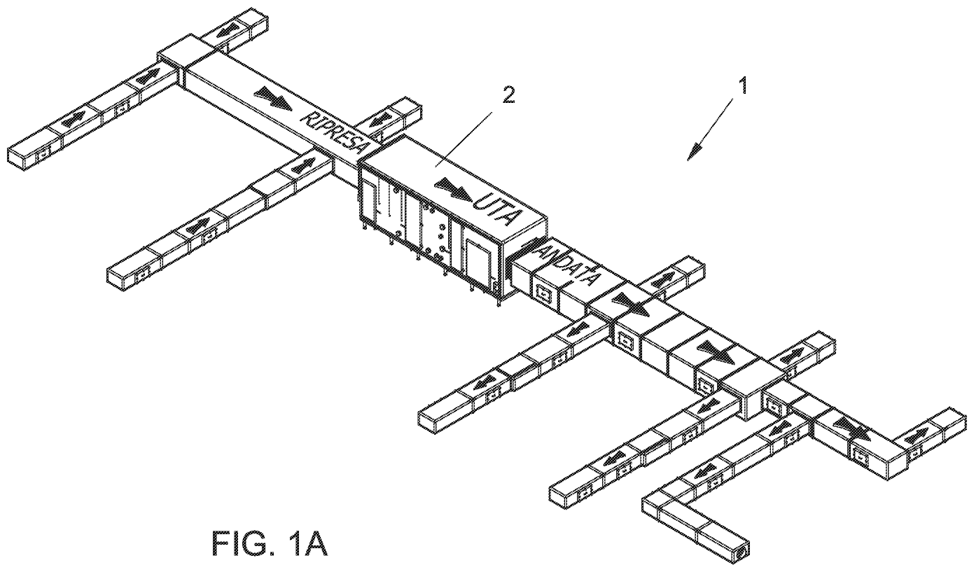

The duct of the invention, indicated as a whole by the numeral 1 in FIG. 1, is used to circulate air from an external environment, or from the air generator 2 in FIG. 1A, through the respective inlet and outlet sections 3.

From these sections the air is circulated inside the duct 1, towards the internal environment to be treated, passing through the corresponding sections 4 for air transit between adjacent modules 5 forming the duct 1.

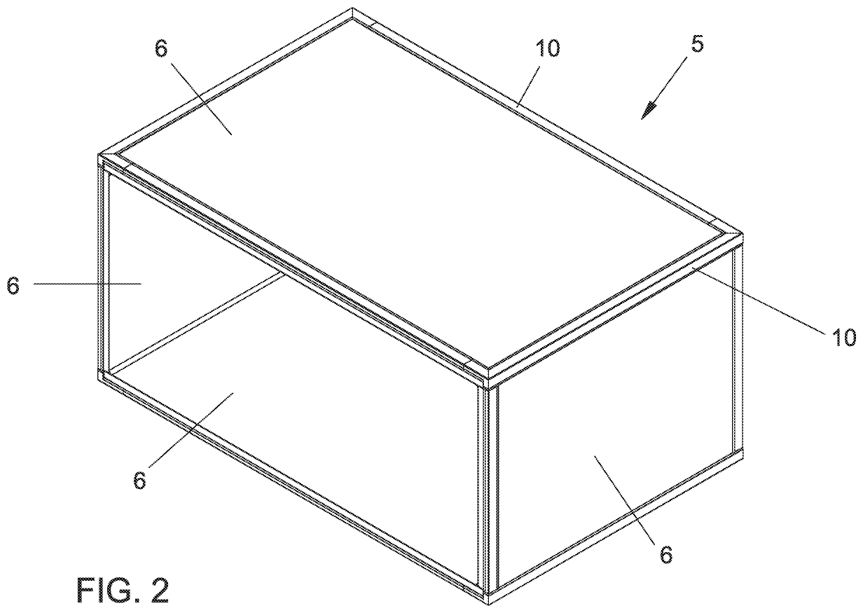

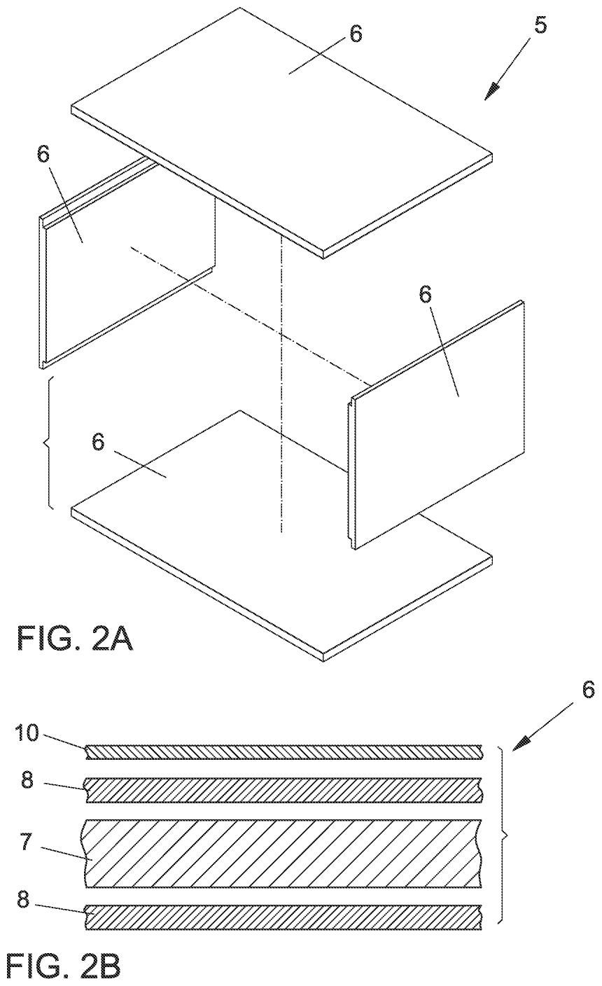

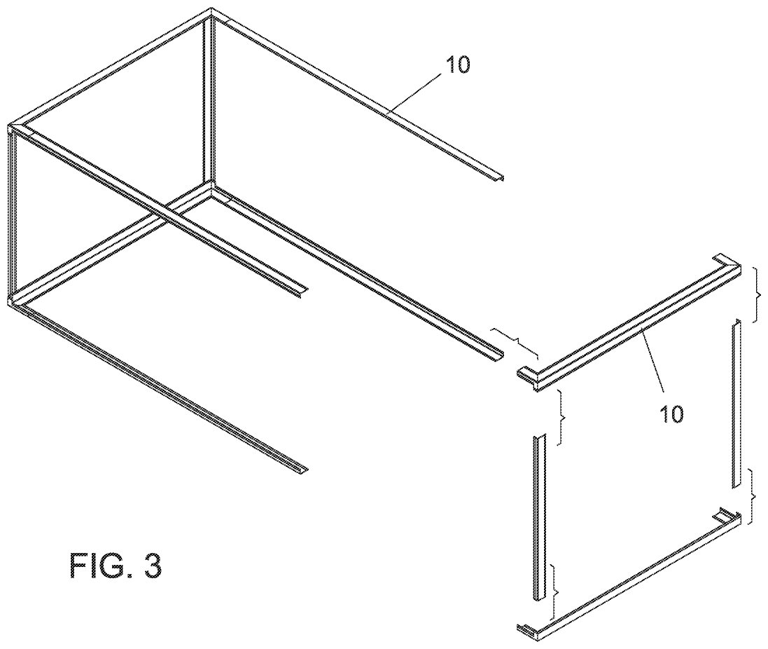

As illustrated in FIGS. 2 and 2A, each module 5, whose dimensions are selected depending on parameters such as the flow rate, temperature and speed of the air circulating in the duct 1, or for example on the pressure drops and so on, substantially has the shape of a parallelepiped, a cube or another quadrangular shape, obtained by assembling the respective panels 6, better shown in FIG. 2B, having a monolithic structure.

In particular, each panel 6 of the modules 5 has a sandwich-type monolithic structure, having a central body 7 of insulating material of various thicknesses, such as polystyrene, polyurethane, rock wool and the like, coated on the top and the bottom with a layer 8 of various thickness of protective stiffening material, for example fiberglass and the like.

Advantageously, the edges of the panels forming the module 5 are joined by means of interlocking couplings 9 and with the aid of glue. However, other forms of coupling are possible.

The structure of the modules 5 is finally completed by rigid reinforcement ring profiles 10, applied at the external perimeter edges of said modules 5.

Preferably, the profiles 10 are made of steel, fixed to each other by welding and fixed to the external coating 8 of the modules 5 by gluing or the like.

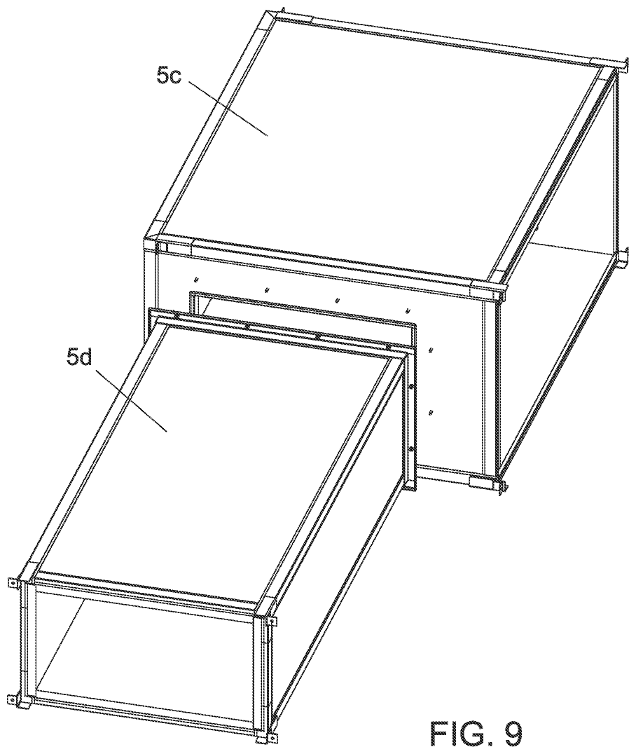

FIGS. 7 and 8 illustrate an example of mutual fixing between modules 5a and 5b having an equal air passage section. In this embodiment, the coupling between adjacent modules is achieved by means of brackets 11, welded or glued to the profiles 10 of the modules 5 and bearing protruding tabs or flaps 12 provided with holes for respective bolts 13 or other similar fastening systems.

The assembly is completed by a gasket 14 made of elastic material, placed between the sections 15 and 16 connecting the modules 5a and 5b, suitable for ensuring the necessary airtight conditions and for optimizing the coupling.

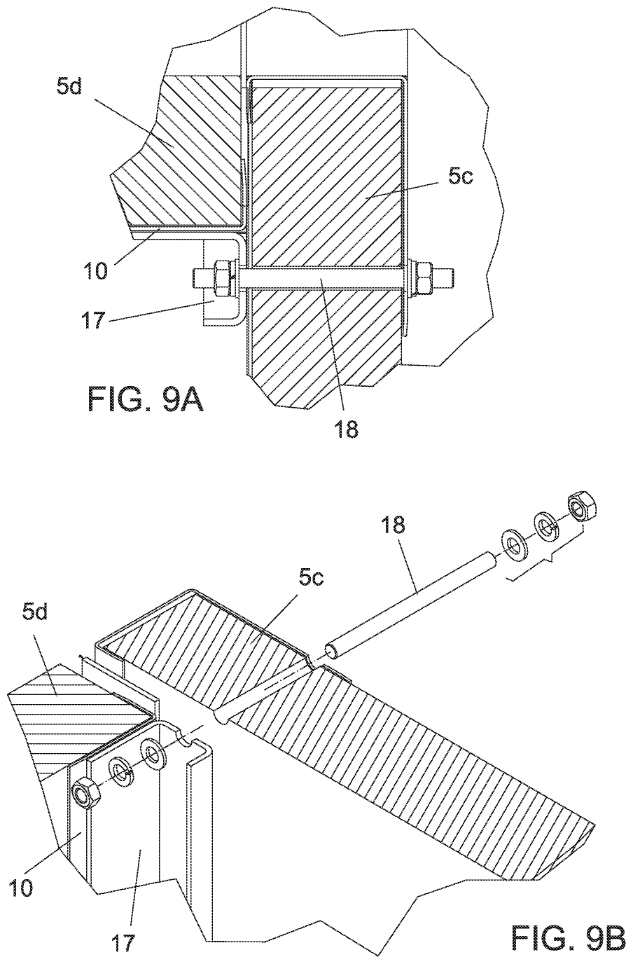

In the case of coupling between modules 5c and 5d with different coupling sections, as illustrated in FIGS. 9, 9A, and 9B, “L” shaped brackets 17 are used, fixed to the profiles 10 of the respective module panels by welding, gluing and the like. The coupling is completed by means of a threaded rod 18.

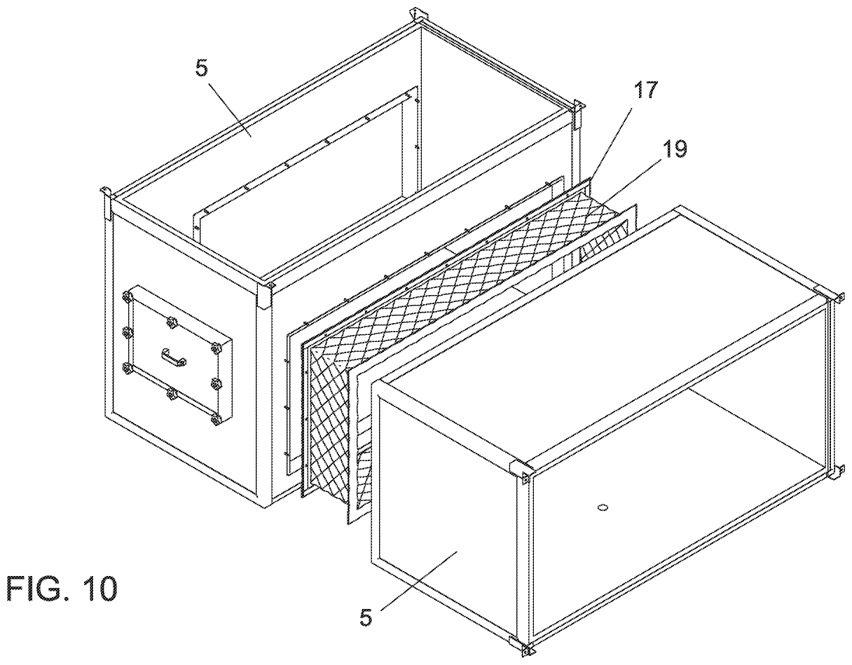

In the variant of FIGS. 10, 10A, and 10B, on the coupling sections between adjacent modules 5 there is a joint 19 made of deformable material, such as a plastic material or an elastic or flexible fabric, with the function of dimensional compensation to correct the coupling (alignment, distance) during the assembly phase of the duct.

In this case the joint 19 consists of a thickness of said elastic material, fixed to the body of the panels 6 by means of elements such as the brackets 17 and the threaded bar 18 of the previous Figures.

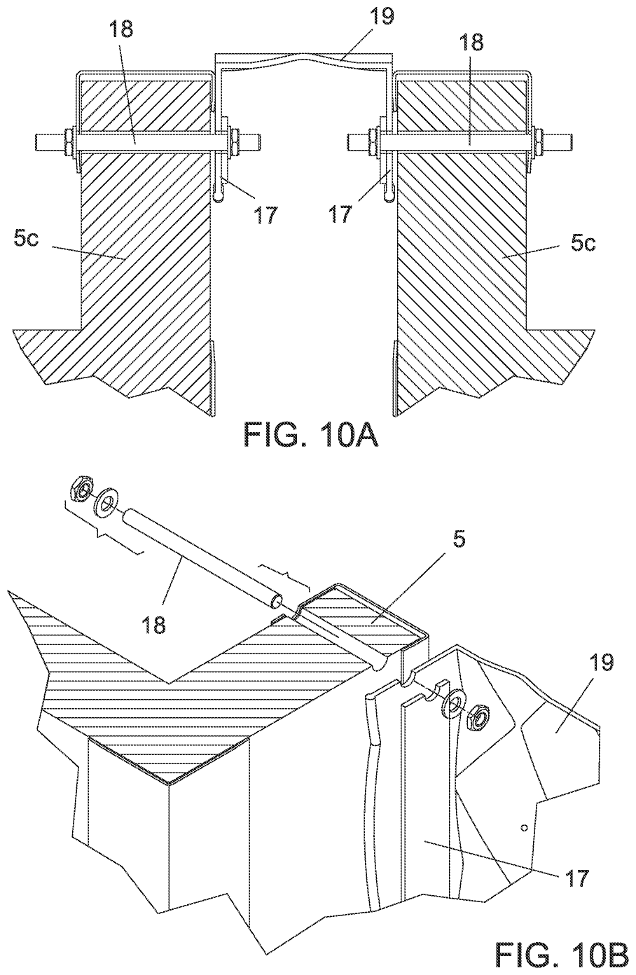

In the variant of FIG. 11, inside the module 5 deflectors 20 are fixed, consisting of shaped profiles suitable for conveying the air towards the adjacent module 5.

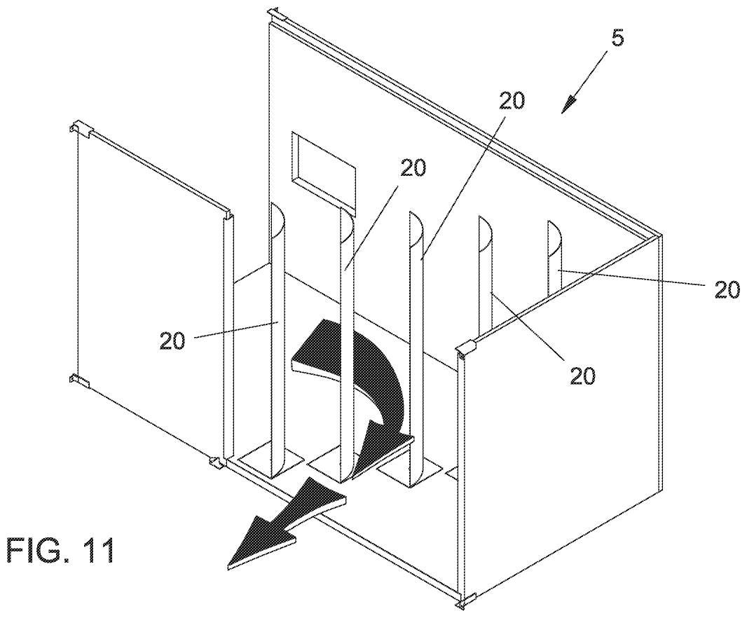

As illustrated in FIGS. 12 and 12A, on the bottom panel 6 of the modules a water or condensation drain 21 is preferably provided, in turn formed by a sleeve 22, the outlet of which is closed by means of a plug 23.

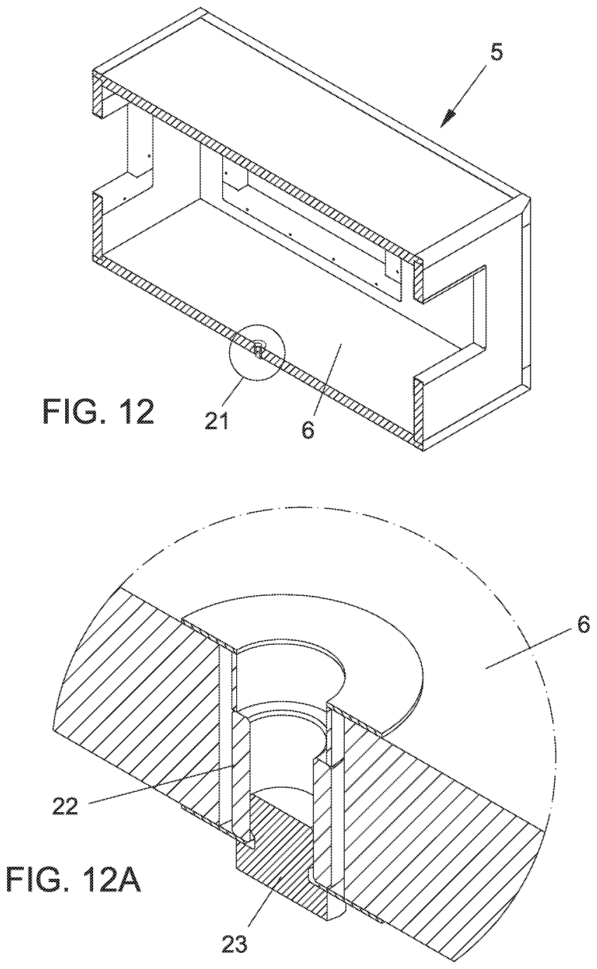

FIG. 13 shows the detail of the air transit sections 4, provided with an element 24, for example a grill or a vent, suitably sized to regulate the air flow.

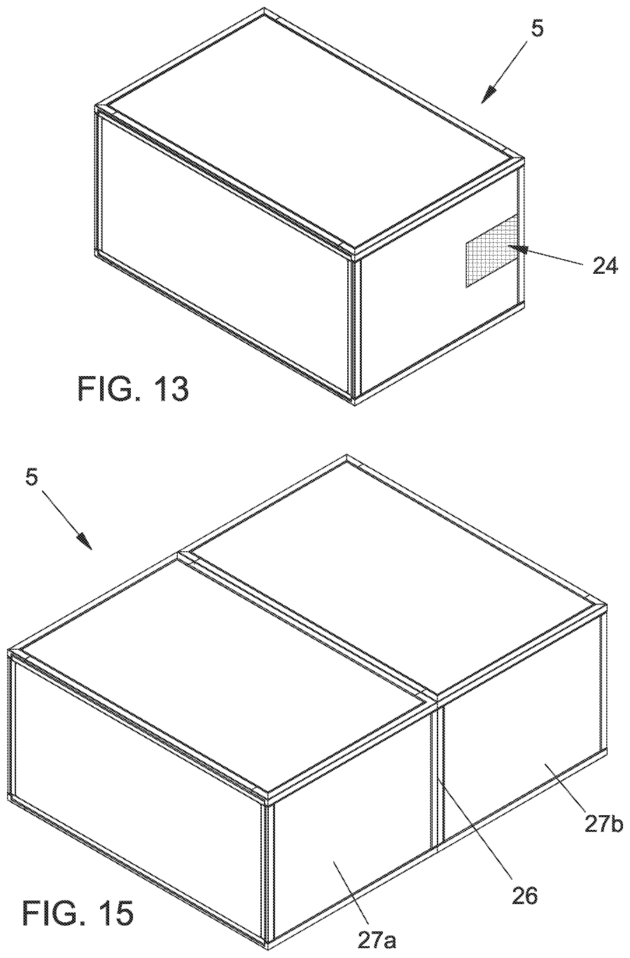

FIGS. 14 and 14A show the inspection door 25 of the modules 5 of the duct 1 of FIG. 1, located at the respective manhole.

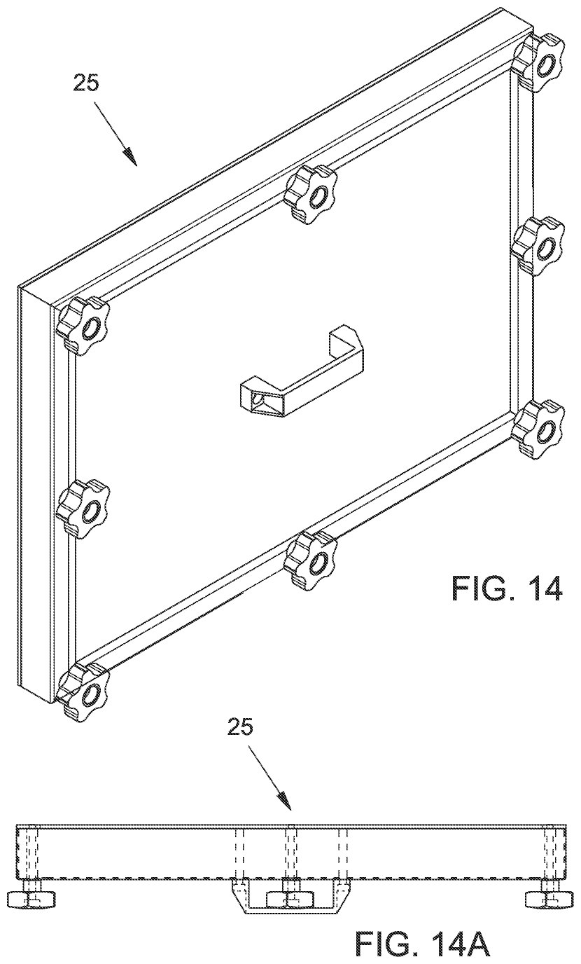

In the variant of FIG. 15, the module 5 of the invention is provided with a single or multiple sub-horizontal or sub-vertical internal partition 26 forming channels 27a and 27b for independent air passage.

1. A module for air circulation ducts, of the type consisting of a quadrangular body formed by panels (6) mutually assembled at their longitudinal edges and provided with sections (4) for air transit between adjacent modules (5); said panels (6) presenting a sandwich-type monolithic structure, having a central body (7) made of heat-insulating material, coated on the external surfaces with a layer (8) of protective stiffening material; said module being characterized in that it comprises a joint (19) of deformable material for dimensional compensation of the coupling between two adjacent modules.

2. The module according to claim 1, characterized in that said panels (6) are coupled at said longitudinal edges by means of an interlocking coupling (9).

3. The module according to claim 1, characterized in that it is also provided with profiles (10), applied to the module (5) at its external perimeter edges.

4. The module according to claim 3, characterized in that it is provided with brackets (11) equipped with tabs or flaps (12) for mutual fixing between adjacent modules (5a,5b) having the same section.

5. The module according to claim 3, characterized in that it is provided with “L” shaped brackets (17) for mutual fixing between adjacent modules (5c,5d) having different sections.

6. The module according to claim 1, characterized in that it is provided with internal deflectors (20) for conveying the air in a predetermined direction.

7. The module according to claim 1, characterized in that it is provided with a drain (21) on the bottom panel (6), wherein said drain (21) is formed by a sleeve (22) closed by a plug (23).

8. The module according to claim 1, characterized in that it comprises a single or multiple sub-horizontal or sub-vertical internal partition (26) forming channels (27a,27b) for independent air passage.

9. The module according to claim 1, characterized in that it is provided with elements (24) for controlling the passage of air from said sections (4).

10. The module according to claim 1, characterized in that it is provided with an inspection door (25).

11. A duct for air circulation, characterized in that it consists of at least one module (5) according to claim 1.

12. The duct according to claim 11, characterized in that it is provided with at least one air inlet/outlet section (3).

13. The duct according to claim 12, characterized in that it also comprises an air generator (2).

14. The duct according to claim 11, characterized in that it consists of a plurality of modules (5) with different dimensions.
